(19) United States
(12) Patent Application Publication
(10) Pub. No.: US 2013/0181522 A1
(43) Pub. Date: Jul. 18, 2013

(54) Power Management Control Circuit

(71) Applicants: Hsuan-Kai Wang, New Taipei City (TW); Nien-Hui Kung, Hsinchu City (TW)

(72) Inventors: Hsuan-Kai Wang, New Taipei City (TW); Nien-Hui Kung, Hsinchu City (TW)

(73) Assignee: Richtek Technology Corporation, R.O.C.

(21) Appl. No.: 13/352,020

(22) Filed: Jan. 17, 2012

(51) Int. Cl. H02J 1/04; H02J 7/34

(52) U.S. Cl. 307/33; 320/164

(57) ABSTRACT

A power management control circuit controls a first power transistor to convert a input voltage to an output voltage and controls a second power transistor to charge a battery from the output voltage. The first power transistor is coupled between the input voltage and the output voltage, and the second power transistor is coupled between the output voltage and the battery. The power management control circuit includes: a detection transistor detecting a current through the second power transistor and generating a charging reference voltage; an amplifier comparing the output voltage with the voltage of the battery to generate an amplified signal for controlling the charging reference voltage; a comparator comparing a reference voltage with the charging reference voltage to generate an EOC (End of Charge) signal for determining whether to stop charging the battery; and an offset voltage compensation device compensating an input offset voltage of the amplifier.

### BACKGROUND OF THE INVENTION

1. Field of Invention

The present invention relates to a power management control circuit, in particular to such a power management control circuit capable of concurrently providing power to a load circuit and charging a battery.

2. Description of Related Art

FIG. 1 shows a schematic diagram of a prior art power management control circuit. Referring to FIG. 1, a portable electronic device usually has a battery 14 which requires to be charged from an external power supply. The power for example can be received from an adapter or a USB (through an input node), so an input voltage Vin is obtained thereby. In certain applications, a system may need to operate directly under the external power when the battery is out of charge or when the battery is removed. Therefore, the circuit structure is designed as shown, in which the system can receive an input voltage Vin from the adapter or USB, or receive power from the battery 14. The power path for receiving external power is controlled by a power transistor Q1, and this power transistor can be controlled by a control circuit 10 to generate a system voltage Vsys. The control circuit 10 detects the input voltage Vin, the system voltage Vsys, and the battery voltage Vbat, and generates signals for controlling the power transistors Q1 and Q2 so that the system voltage Vsys and the battery voltage Vbat are properly maintained. The external power can simultaneously provide power to both the system and the battery 14. That is, when the power of the battery 14 is low, the external power charges the battery 14 while supplying power to the system.

The control circuit 10 can select a CC (Constant Current) mode or a CV (Constant Voltage) mode according to the charging status of the battery 14, whereby the battery 14 is charged by constant current or by constant voltage. When the system load is heavy to an extent that the external power cannot provide sufficient currents to both the system and battery 14, the control circuit 10 switches to an APPM (auto power path manager) mode, and the system voltage Vsys drops from 4.4 volts to and keeps at the voltage VAPPM (in general, the voltage VAPPM is set above 4.2 volts, which is larger than or equal to the saturation voltage of the battery). When the input voltage Vin is smaller than VAPPM, the charging current of the battery 14 drops to 0 A. In addition, if the maximum current provided from the input side is lower than the setting value of the charging current of the battery 14, the control circuit 10 also switches to the APPM mode.

When VAPPM is set to 4.2 volts and the input voltage Vin drops to 4.3 volts due to line loss, the current through the power transistor Q1 (assuming that its on-state resistance is 0.3 Ohm) is 333 mA. If the system load is heavy or a larger charging current to the battery 14 is desired, the current of 333 mA obviously cannot satisfy the requirement.

In view of above, the present invention overcomes the foregoing drawbacks by providing a power management control circuit. The foregoing problems can be resolved.

### SUMMARY OF THE INVENTION

The present invention provides a power management control circuit for controlling a first power transistor to convert an input voltage to an output voltage and controlling a second power transistor to charge a battery from the output voltage, wherein the first power transistor is coupled between the input voltage and the output voltage, and the second power transistor is coupled between the output voltage and the battery, the power management control circuit comprising: a detection transistor detecting a current through the second power transistor and generating a charging reference voltage; an amplifier comparing the output voltage with the voltage of the battery to generate an amplified signal for controlling the charging reference voltage; a comparator comparing a reference voltage with the charging reference voltage to generate an EOC (End of Charge) signal for determining whether to stop charging the battery; and an offset voltage compensation device compensating an input offset voltage of the amplifier.

In one embodiment of the present invention, the offset voltage compensation device is a resistor coupled to a positive terminal of the amplifier.

In one embodiment of the present invention, the offset voltage compensation device includes an offset voltage detection circuit and a compensation voltage generator coupled to the offset voltage detection circuit, the offset voltage compensation device detecting the input offset voltage to generate a corresponding compensation voltage.

In one embodiment of the present invention, the offset voltage compensation device sets an equivalent offset voltage of a negative terminal of the amplifier to be not more than zero.

In one embodiment of the present invention, the power management control circuit comprises a CC/CV/APPM loop control circuit for designating an operation mode to the second power transistor.

In one embodiment of the present invention, the output voltage is set smaller than the saturation voltage of the battery in the APPM mode.

The objectives, technical details, features, and effects of the present invention will be better understood with regard to the detailed description of the embodiments below, with reference to the drawings

### BRIEF DESCRIPTION OF THE DRAWINGS

FIG. 1 shows a schematic diagram of a prior art power management control circuit.

FIG. 2 shows a schematic diagram of a prior art power management control circuit.

FIG. 3 shows a waveform diagram of the voltages and currents in the circuit of FIG. 2.

FIG. 4 shows a schematic diagram of a power management control circuit according to the present invention.

FIG. 5 shows a schematic diagram of another power management control circuit according to the present invention.

FIG. 6 shows another embodiment of the present invention, automatically detecting the input offset voltage to generate a corresponding compensation voltage.

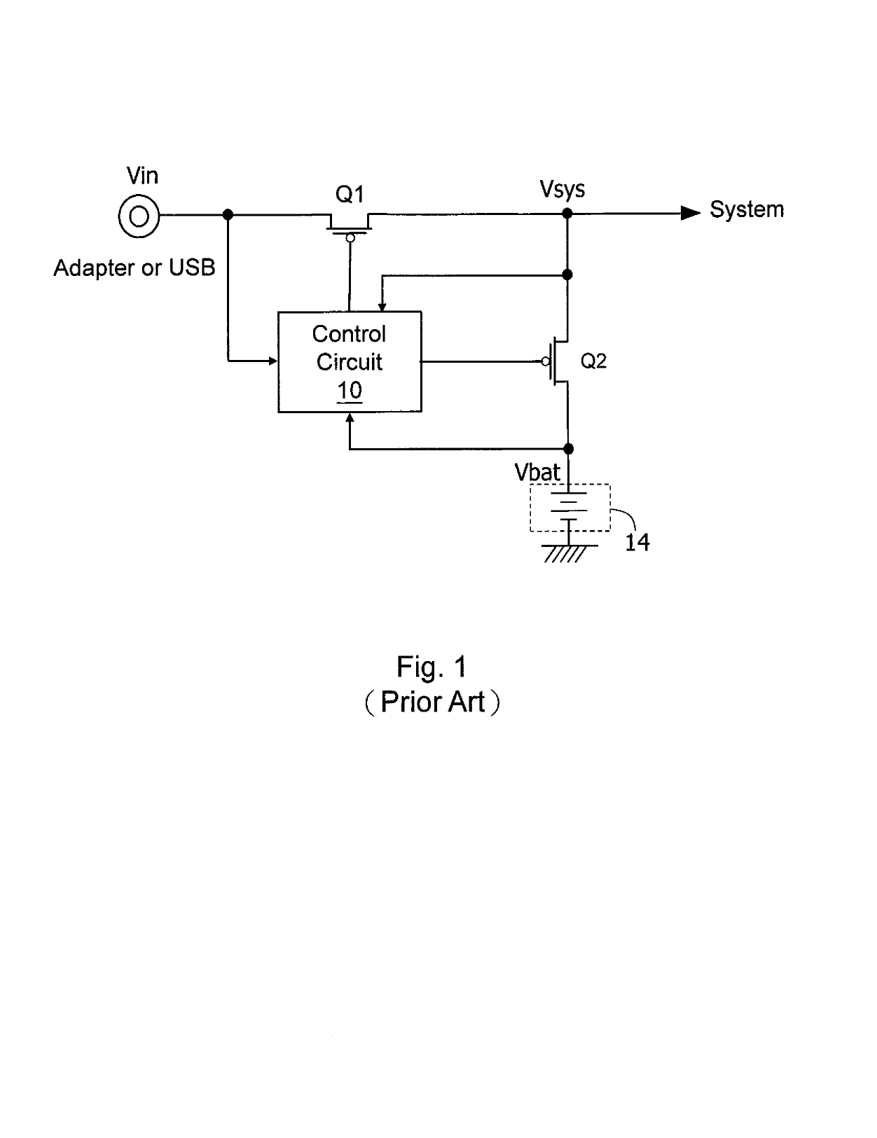

### DESCRIPTION OF THE PREFERRED EMBODIMENTS

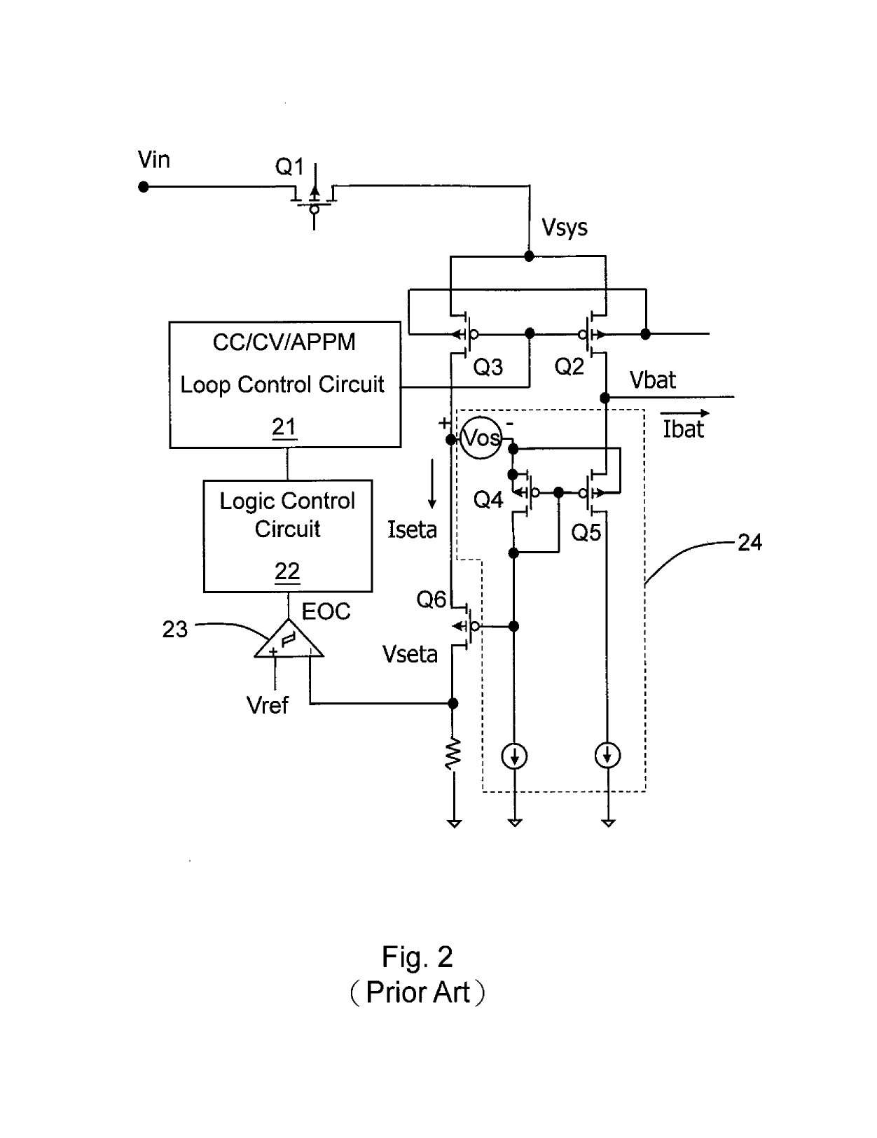

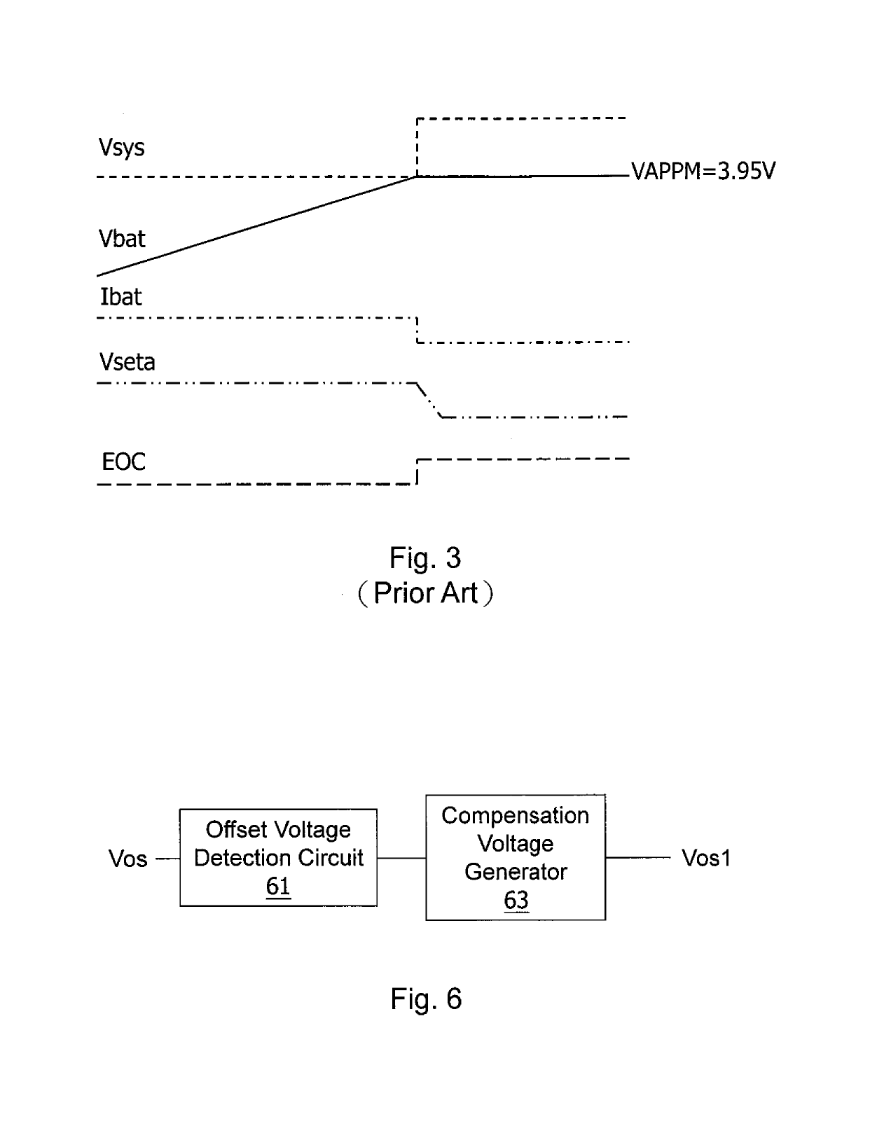

As mentioned above, when VAPPM is set to be 4.2 volts and the input voltage drops to 4.3 volts due to line loss, the current through the power transistor Q1 (assuming that its on-state resistance is 0.3 Ohm) is 333 mA. If the system load is heavy or a larger charging current to the battery 14 is desired, the current of 333 mA obviously cannot satisfy the requirement. The inventor thus proposes to set VAPPM (or its detection point) to 3.95 volts. Thus, the current through the power transistor Q1 is increased. However, when the setting value of VAPPM is dropped to 3.95 volts, the battery voltage Vbat often stops at 3.95 volts and stops rising any more because of the inherent input offset voltage of the control circuit 10. The battery 14 cannot be charged to the upper limit of 4.2 volts so the storage capacity of the battery 14 cannot be sufficiently utilized. FIGS. 2 and 3 explain why the battery stops being charged when the storage capacity of the battery 14 is not saturated due to the input offset voltage.

FIG. 2 shows a schematic diagram of a power management control circuit. FIG. 3 shows a waveform diagram of the voltages and currents in the circuit of FIG. 2. As show in these figures, the transistor Q3 is a detection transistor, which detects the current through the power transistor Q2 (which is about equal to the charging current Ibat) to generate a current Iseta. The amplifier 24 includes transistors Q4 and Q5. Because the manufacturing process may cause mismatches between Q4 and Q5, an input offset voltage may exist between the two input terminals of the amplifier 24, in general around ±40 mV. If the input offset voltage Vos is at the negative input terminal and is larger than 0 volt (a voltage source device Vos connected to the negative terminal of the amplifier 24 is shown in the figure to represent this offset voltage, but it should be noted that the input offset voltage needs not be a physical device), when the battery voltage Vbat is near 3.95 volts, the current Iseta through the transistor Q6 becomes very small because the system voltage Vsys is locked at the setting value of VAPPM (3.95 volts). That is, it is incorrectly determined that the charging current Ibat to the battery is approximate zero. (For example, in normal condition Ibat/Iseta is around 1/300; however, in the above case, Ibat/Iseta is around 1/3000 so that the charging current Ibat is incorrectly deemed as approximate zero). The hysteresis comparator 23 compares the voltage Vseta with a reference voltage Vref such as 66 mV, and the EOC (End of Charge) signal changes from a low level to a high level when the voltage Vseta is smaller than the reference voltage. The logic control circuit 22 receives the EOC signal and controls the CC/CV/APPM loop control circuit 21 such that the power transistor Q2 is turned off. Thus, the battery 14 stops being charged when the voltage of the battery 14 has not yet reached the saturation voltage 4.2 volts. The major function of the CC/CV/APPM loop control circuit 21 is to determine an operation mode (the CC, CV, or APPM mode) of the second power transistor Q2.

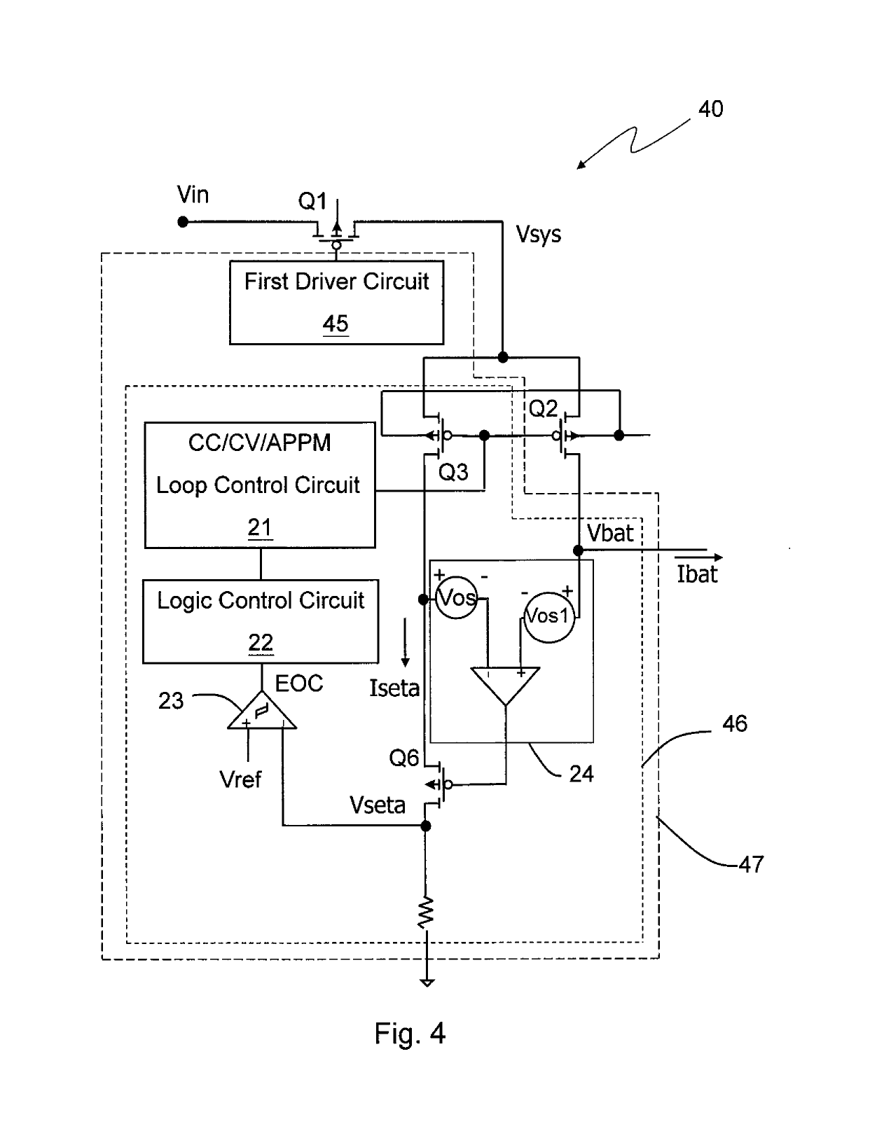

To resolve the problem that the battery voltage is incorrectly determined to have been fully charged, FIG. 4 shows a schematic diagram of a power management control circuit of a preferred embodiment of the present invention. The supply path of the external power is controlled by the power transistor Q1. The first driver circuit 45 controls the power transistor Q1 to generate the system voltage Vsys. The first driver circuit 45 detects the input voltage Vin and the system voltage Vsys to generate a signal controlling the power transistor Q1 so that the system voltage Vsys is properly regulated. The second driver circuit 46 controls the power transistor Q2. It detects the charging current Ibat and the battery voltage Vbat to generate a signal controlling the power transistor Q2 so that the battery voltage Vbat is properly maintained. The external power can simultaneously supply power to the system voltage Vsys and the battery voltage Vbat. That is, it charges both of them particularly when the battery power is insufficient.

As mentioned above, when an input offset voltage Vos (larger than zero) exists at the negative input terminal of the amplifier 24, the battery stops being charged too early. However in the present embodiment of FIG. 4, an offset voltage compensation device Vos1 is disposed at the positive input terminal of the amplifier 24. This compensates the input offset voltage Vos, so the current Iseta through the transistor Q6 would not become too small. The hysteresis comparator 23 compares the voltage Vseta with a reference voltage Vref, such as but not limited to 66 mV. The EOC (End of Charge) signal still maintains at a low level when the battery is not fully charged, because the voltage Vseta is larger than the reference voltage. Thus, the charging current does not stop charging the battery 14. When the battery voltage Vbat reaches 3.95 volts, the power management control circuit 40 can switch to the CV mode, and the battery voltage Vbat continuously rises, until 4.2 volts. When the logic control circuit 22 receives the EOC signal, it controls the CC/CV/APPM loop control circuit 21 to turn off the power transistor Q2. Thus, the charging operation stops when the voltage of the battery 14 reaches the saturation voltage 4.2 volts.

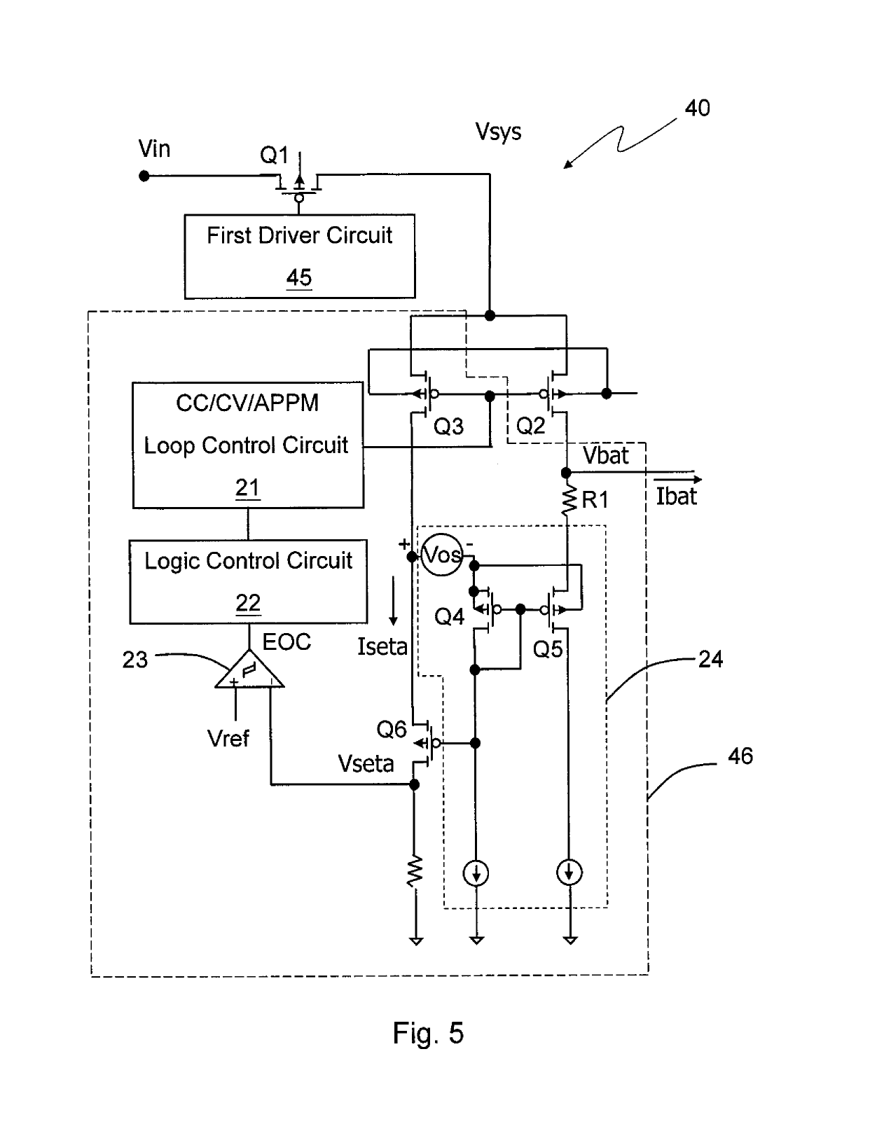

In this embodiment, the offset voltage compensation device Vos1 is an internal device included in the amplifier 24 of FIG. 4. However, the offset voltage compensation device Vos1 is not necessarily disposed inside the amplifier 24, and it can be a physical device or non-physical device. When the offset voltage compensation device Vos1 is a physical device, as shown in FIG. 5, the offset voltage compensation device Vos1 may be, but not limited to, a resistor R1 inside of outside of the amplifier 24 (R1 can be an internal device or an external device of the amplifier 24). When the offset voltage compensation device Vos1 is a non-physical device, for example, a voltage difference can be intentionally provided between two input terminals of the amplifier 24 by controlling its manufacturing process. As an example but not limitation, the size of the transistor Q5 and/or the resistance of the line between it and the voltage node Vbat can be intentionally controlled. Note that in the above illustration, a positive input offset voltage exists at the negative input terminal. Equivalently, there could be a negative input offset voltage existing at the positive terminal, causing the same problem. Therefore, the offset voltage compensation device Vos1 can also be disposed at the negative input terminal with an equivalent value to generate the desired effect, and the example illustrated in the figure should not be taken as a limitation to the scope of the present invention. In brief, the present invention sets an equivalent offset voltage of a negative terminal of the amplifier 24 to be not more than zero by providing a physical or non-physical offset voltage compensation device Vos1. Thus, the battery charging will not be stopped too early.

In addition, the offset voltage compensation device Vos1 can be a more complicated circuit instead of a simple resistor R1, such as an automatic offset voltage generator, an automatic offset cancellation circuit or an automatic zero adjustment circuit. An example is shown in FIG. 6; it can include an offset voltage detection circuit 61 and a compensation voltage generator 63. Thus, the input offset voltage can be automatically detected, and the compensation voltage is generated accordingly. Furthermore, as shown in FIG. 5, the circuits other than the power transistors Q1 and Q2 can be integrated into a power management control circuit 47. And if the manufacturing process allows, the power transistors Q1 and Q2 certainly can also be integrated into the power management control circuit 47.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, in all of the embodiments, a device or circuit which does not affect the major functions of the signals, such as a switch, etc., can be added between two circuits illustrated to be directly connected with each other. For another example, the positive and negative terminals of the amplifiers or comparators are interchangeable, with corresponding amendment to the processing of their output signals. Thus, the present invention should cover all such and other modifications and variations, which should be interpreted to fall within the scope of the following claims and their equivalents.

What is claimed is:

1. A power management control circuit for controlling a first power transistor to convert an input voltage to an output voltage and controlling a second power transistor to charge a battery from the output voltage, wherein the first power transistor is coupled between the input voltage and the output voltage, and the second power transistor is coupled between the output voltage and the battery, the power management control circuit comprising:
a detection transistor detecting a current through the second power transistor and generating a charging reference voltage;
an amplifier comparing the output voltage with the voltage of the battery to generate an amplified signal for controlling the charging reference voltage;
a comparator comparing a reference voltage with the charging reference voltage to generate an EOC (End of Charge) signal for determining whether to stop charging the battery; and
an offset voltage compensation device compensating an input offset voltage of the amplifier.

2. The power management control circuit of claim 1, wherein the offset voltage compensation device is a resistor coupled to a positive terminal of the amplifier.

3. The power management control circuit of claim 1, wherein the offset voltage compensation device includes an offset voltage detection circuit and a compensation voltage generator coupled to the offset voltage detection circuit, the offset voltage compensation device detecting the input offset voltage to generate a corresponding compensation voltage.

4. The power management control circuit of claim 1, wherein the offset voltage compensation device sets an equivalent offset voltage of a negative terminal of the amplifier to be not more than zero.

5. The power management control circuit of claim 1, wherein the power management control circuit comprises a CC/CV/APPM (Constant Current/Constant Voltage/Auto Power Path Management) loop control circuit for designating an operation mode of CC, CV, or APPM to the second power transistor.
